(19) United States
(12) Patent Application Publication
(10) Pub. No.: US 2013/0046687 A1
(43) Pub. Date: Feb. 21, 2013

(54) UNDERBANKED AND UNBANKED METHOD AND MODULE

(71) Applicant: William H. Simpson, JR., Hoover, AL (US)

(72) Inventor: William H. Simpson, JR., Hoover, AL (US)

(73) Assignee: Regions Asset Company, Wilmington, DE (US)

(21) Appl. No.: 13/588,763

(22) Filed: Aug. 17, 2012

Related U.S. Application Data
(60) Provisional application No. 61/525,520, filed on Aug. 19, 2011.

(51) Int. Cl. G06Q 30/04

(52) U.S. Cl. 705/40

(57) ABSTRACT

An underbanked and unbanked method and module associated with a financial institution to effect generating cash funds from a check, loading these cash funds onto a general purpose reloadable prepaid card, and using these cash funds to facilitate cash to cash money transfers and bill payments for banking customers regardless of whether the customer is a deposit or non-deposit customer of the financial institution. The underbanked and unbanked module can include a check cashing module, a reloadable debit card system, a money remittance system and a bill payment system that are integrated with each other. The customer may use the funds dispensed from the underbanked and unbanked module to obtain cash, load a reloadable debit card, pay for purchases, pay bills, obtain a money order and/or to facilitate cash to cash money transfers.

### CLAIM OF PRIORITY

This application claims priority to provisional U.S. application No. 61/525,520, filed Aug. 19, 2011, which is incorporated by reference in its entirety.

### TECHNICAL FIELD

The present invention relates generally to providing cash banking services to Underbanked and Unbanked consumers whose banking relationship is built on being able to access cash and “pay as you go”. More specifically, the present invention provides an underbanked and unbanked method and module to effect generating cash funds from a check, loading these cash funds onto a general purpose reloadable prepaid card, and using these cash funds to facilitate cash to cash money transfers and bill payments. Furthermore, the underbanked and unbanked module relates to the integration of a check cashing system, a general purpose reloadable prepaid card system, a money remittance system and a bill payment system.

### BACKGROUND

Cash banking describes the behavior of consumers whose banking relationship is built on their ability to access cash and “pay as you go,” regardless of whether they have an account at a respective financial institution. The current traditional banking behavior is that of a deposit customer who has an account at a respective financial institution and whose banking relationship is built on this account. Traditional deposit customers may have their paychecks direct deposited into their accounts, cash checks and pay bills with checks or online banking. However, even without necessarily having an account at a representative financial institution, cash banking customers need to have access to cash, and further require the ability to cash any kind of check regardless of whether they have an account at a respective financial institution, to make purchases with cash or prepaid cards, and to pay bills with cash, money orders or other bill payment services.

### SUMMARY

The invention relates to providing a underbanked and unbanked method and module to effect generating cash funds from a check, loading these cash funds onto a general purpose reloadable prepaid card, and using these cash funds to facilitate cash to cash money transfers and bill payments.

In one aspect, an underbanked and unbanked method and module may generate cash from a check, and may include a general purpose reloadable prepaid card system, a money remittance system for facilitating cash to cash money transfers, and a bill payment system. The general purpose reloadable prepaid card system, the money remittance system and the bill payment system, of the underbanked and unbanked module, can be integrated with each other.

In another aspect, a banking method can include enrolling a customer in an underbanked and unbanked module associated with a financial institution regardless of whether the customer is a deposit or non-deposit customer of said financial institution, receiving check data and identification data from a customer, verifying said check data and identification data, upon verifying the check data, dispensing funds to the customer, loading funds onto a general purpose reloadable prepaid card, facilitating cash to cash money transfers, and facilitating bill payments to a network of billers. In certain circumstances, the method can include verifying the name, physical address, social security number, date of birth and government issued photo ID of the customer.

The system can include an enrollment system for enrolling a customer in the underbanked and unbanked module associated with a financial institution regardless of whether the customer is a deposit or non-deposit customer of said financial institution. The underbanked and unbanked module can be configured to verify the name, physical address, social security number, date of birth and government issued photo ID of the customer.

In certain circumstances, the system can include a data receiver for receiving check data and identification data from a customer, and a fund dispenser for dispensing funds associated with the check presented to the system. The system can interface with a check verification system to approve or decline the disbursement of funds with a full guarantee by a third party vendor. For example, the dispensed funds can include cash, a general purpose reloadable prepaid card or a savings account. The dispensed funds can be used to facilitate cash to cash money transfers, bill payments and/or money orders. Both the check verification system and the fund dispenser may comprise a computer implemented system. The check verifying and fund dispensing may also be performed manually by an individual associated with the financial institution.

In certain circumstances, the check cashing system, the general purpose reloadable prepaid card system, the money remittance system and the bill payment system can be integrated with each other to allow a customer to use the funds dispensed from the underbanked and unbanked module, load a general purpose reloadable prepaid card with these funds, pay for purchases, pay bills, obtain a money order and/or to facilitate cash to cash money transfers.

In certain circumstances, the system can include a system for providing a line of credit to the customer based on the customer's deposit history, at the financial institution associated with the system and/or at a location other than the financial institution associated with the system; a system for providing short term loans, which are paid off by the end of the customer's next respective pay period, and loans, which are a mixture of a lease and an option to buy within a certain period of time, may be included.

In another aspect, a general purpose reloadable prepaid card system can include a system in which the customer loads funds onto a general purpose reloadable prepaid card, the customer uses the card to pay for purchases, pay bills and/or obtain cash from ATMs, and the customer may reload additional funds onto the card. The funds for the general purpose reloadable prepaid card can include cash. In certain circumstances, the funds for the general purpose reloadable prepaid card can be loaded from an existing account at the financial institution or directly deposited onto the card. Funds directly deposited onto the general purpose reloadable prepaid card can include the customer's wages, tax refunds and/or state disbursements. For example, the funds may be loaded onto the general purpose reloadable prepaid card at a financial institution associated with the underbanked and unbanked module or at a network location other than the financial institution associated with the underbanked and unbanked module.

The details of one or more embodiments are set forth in the following detailed description of the invention and the accompanying drawings. Other objectives, features, and advantages of the invention will be more readily understood upon consideration of the following detailed description of the invention, taken in conjunction with the accompanying drawings, and with the claims.

### DESCRIPTION OF DRAWINGS

FIG. 1 illustrates the system of an exemplary underbanked and unbanked module, for generating cash funds from a check, loading these cash funds onto a general purpose reloadable prepaid card, and using these cash funds to facilitate cash to cash money transfers and bill payments.

FIG. 2 (comprising FIG. 2A, FIG. 2B, and FIG. 2C) provides flow charts indicating how the, general purpose reloadable prepaid card system, money remittance system and enrollment system, of the underbanked and unbanked module, are integrated with each other to provide cash banking customers with immediate access to cash.

### DETAILED DESCRIPTION

An underbanked and unbanked method and module for both deposit and non-deposit customers of a financial institution can generate cash funds from a check, load these cash funds onto a general purpose reloadable prepaid card, and use these cash funds to facilitate cash to cash money transfers and bill payments. The underbanked and unbanked method and module, which is associated with a financial institution, includes a general purpose reloadable prepaid card system, a money remittance system and a bill payment system, that are integrated with each other.

A detailed explanation of the system and method according to the preferred embodiments of the present invention is described below.

Cash banking customers bank differently than “traditional” deposit customers as their banking relationship is based on the ability to access cash and pay as you go. Some alternative financial services that cash banking customers require include services for cashing paychecks and making cash deposits; cashing other checks; paying bills with cash, money orders or other bill pay services; making purchases with cash or prepaid cards; making cash to cash money transfers to send money with agents/money remitters; and using small value loans, such as short term loans, which are paid off by the end of the customer's next respective pay period, and loans which are a mixture of a lease and an option to buy within a certain period of time. Common factors assessed by these cash banking customers when choosing a financial provider include convenient locations and hours, the required minimum account balances, and the amount of service related fees associated with these transactions. Additionally, cash banking customers often go to check cashers rather than banks to cash checks because their banks put a hold on the respective funds. Recent industry data indicates that a significant banking product gap exists for these cash banking customers who do not fit the traditional banking model.

An underbanked and unbanked module associated with a financial institution can generate cash from any kind of check and for any amount for customers regardless of whether the customer is a deposit or non-deposit customer of the financial institution. The key component of the underbanked and unbanked module is that it enables other alternative Financial Services transactions. The system will allow both deposit and non-deposit customers to cash checks regardless of whether the checks are drawn against the respective financial institution, including “Not-On Us Checks,” such as government, payroll and personal checks, to provide the customers with immediate access to cash.

The underbanked and unbanked module can include a data receiver for receiving check data and identification data from a customer, and a fund dispenser for dispensing funds associated with the check presented to the system. A third party vendor may be used to facilitate this check cashing process, as checks may be approved or declined with a full guarantee by the vendor. For example, a bank teller may scan the front and back of a check, and the information may be submitted to a third party vendor, such as Chexar, for decisioning; the third party vendor may perform OFAC scrubs in evaluating whether or not to approve disbursement of funds to the customer.

The funds dispensed from the check cashing system may include cash, may be loaded onto a general purpose reloadable prepaid card, may be deposited into a savings account, and may be used to facilitate cash to cash money transfers, bill payments and/or money orders. The underbanked or unbanked module may provide a line of credit to the customer based on the customer's deposit history, at either the location of the financial institution associated with the underbanked and unbanked module, or at a location other than the financial institution. Additionally, the underbanked or unbanked module may provide short term loans, which are paid off by the end of the customer's next respective pay period, and loans, which are a mixture of a lease and an option to buy within a certain period of time.

The underbanked and unbanked module can include a general purpose reloadable prepaid card system, which allows a customer to load funds onto a general purpose reloadable prepaid card, which the customer may use to pay for purchases, pay bills and/or obtain cash from ATMs; the general purpose reloadable prepaid card may be a safe alternative to carrying large sums of cash. Customers may purchase goods or services wherever a Visa Debit Card is accepted, and these purchases may be protected by the safeguards of the financial institution associated with the underbanked and unbanked module. The funds loaded onto the general purpose reloadable prepaid card may include cash and may also be loaded from an existing account at the financial institution associated with the underbanked and unbanked module. Additionally, these funds may be directly deposited onto the card, for example, from the customer's wages, tax refunds and/or state disbursements.

The general purpose reloadable prepaid card system can allow a customer to load these funds onto the general purpose reloadable prepaid card at the financial institution associated with the underbanked and unbanked module, and also at a network location other than the financial institution associated with the underbanked and unbanked module. For example, the funds may be loaded onto the card at a bank branch of the respective financial institution associated with the underbanked and unbanked module, at an ATM of the financial institution, or at a reload network location not associated with the respective financial institution. The system may also provide a mechanism for customers to manage their accounts and to track spending via mobile alerts.

The general purpose reloadable prepaid card system may provide a cost effective alternative to check cashing, and may make paying bills, making purchases and obtaining cash fast, convenient, easy and safe. The system may expand the purchasing power of cash banking customers, who are accustomed to relying on cash and checks, by enabling customers to engage in everyday activities such as reserving a hotel room, paying bills online and shopping on the Internet. Additionally, the general purpose reloadable prepaid card system may also reduce cash banking customers' dependence on friends and relatives to cash paychecks or pay bills.

In order for financial institutions to mitigate risks associated with the general purpose reloadable prepaid cards, an aggregate card limit and maximum transaction load at an ATM or reload network location may be established. The customer identifying information may be captured and maintained by a system at the financial institution, which monitors suspicious activities, and may place holds on the funds if suspicious activity is observed, until the suspicious activity is reviewed and cleared.

The underbanked and unbanked module can include a money remittance system for facilitating cash to cash money transfers and a bill payment system for both deposit and non-deposit customers. This money remittance system and bill payment system may facilitate the transfer of funds for a customer to an individual or business around the world via a third party vendor. The money remittance system may provide money transfers in minutes, next day money transfers, and online money transfers. The bill payment system may provide retail expedited payments, online expedited payments and utility payments.

The general purpose reloadable prepaid card system, the money remittance system and the bill payment system, can be integrated with each other and packaged together to allow a customer to use the funds dispensed from the check cashing system to obtain cash, load a general purpose reloadable prepaid card, pay for purchases, pay bills, obtain a money order, and/or facilitate cash to cash money transfers. The customer may utilize this combination of systems to obtain immediate access to cash regardless of whether the customer is a deposit or non-deposit customer of the financial institution; for many cash banking customers, individually, one of these systems of financial services does not adequately meet their complete banking needs.

The underbanked and unbanked module may include an enrollment system for enrolling a customer in the underbanked and unbanked module associated with a financial institution regardless of whether the customer is a deposit or non-deposit customer. The system may be configured to verify the name, physical address, social security number, date of birth and government issued photo ID of the customer.

A banking method may include enrolling a customer in an underbanked and unbanked module associated with a financial institution regardless of whether the customer is a deposit or non-deposit customer of the respective financial institution, receiving check data and identification data from a customer, verifying the check data and identification data, upon verifying said check data, dispensing funds to the customer, loading funds onto a general purpose reloadable prepaid card, facilitating cash to cash money transfers, and facilitating bill payments to a network of billers.

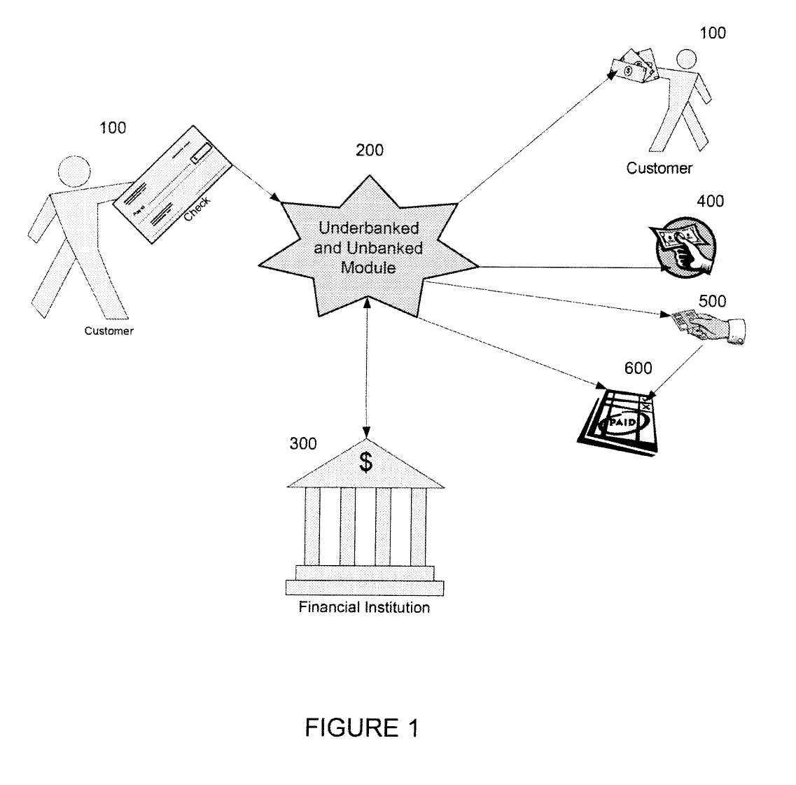

Referring to FIG. 1, an underbanked and unbanked module 200 is associated with a financial institution 300. A customer 100 of the financial institution 300 may present a check to the underbanked and unbanked module 200, which allows both deposit and non-deposit customers 100 to cash any kind of check regardless of whether the checks are drawn against the associated financial institution 300.

The underbanked and unbanked module 200 will process this customer check cashing request. If the check is approved by the system, cash funds may be disbursed to the customer 100. Additionally, the funds dispensed by the underbanked and unbanked module may be used to facilitate cash to cash money transfers 400, money orders and bill payments 600, and may also be deposited into a savings account. Furthermore, the funds dispensed from the underbanked and unbanked module 200 may be loaded onto a general purpose reloadable prepaid card 500. The customer 100 may use the funds dispensed from the underbanked and unbanked module 200 to obtain cash (100), load a general purpose reloadable prepaid card (500), and use the funds loaded onto the general purpose reloadable prepaid card to make bill payments 600.

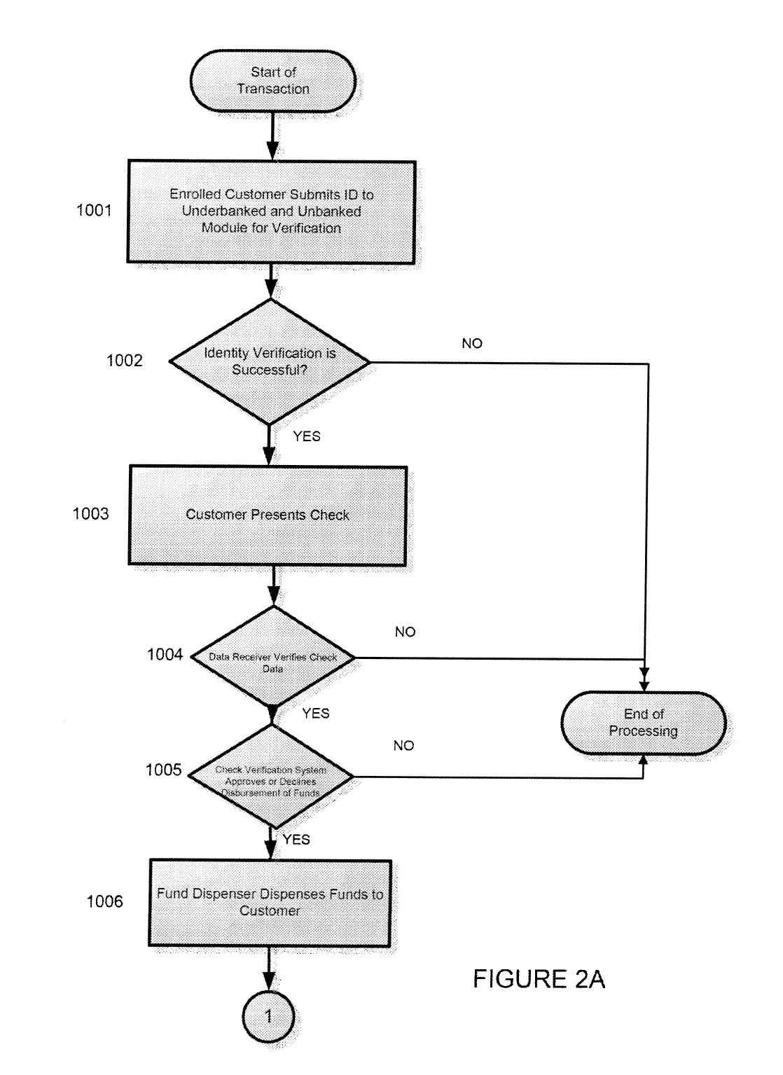

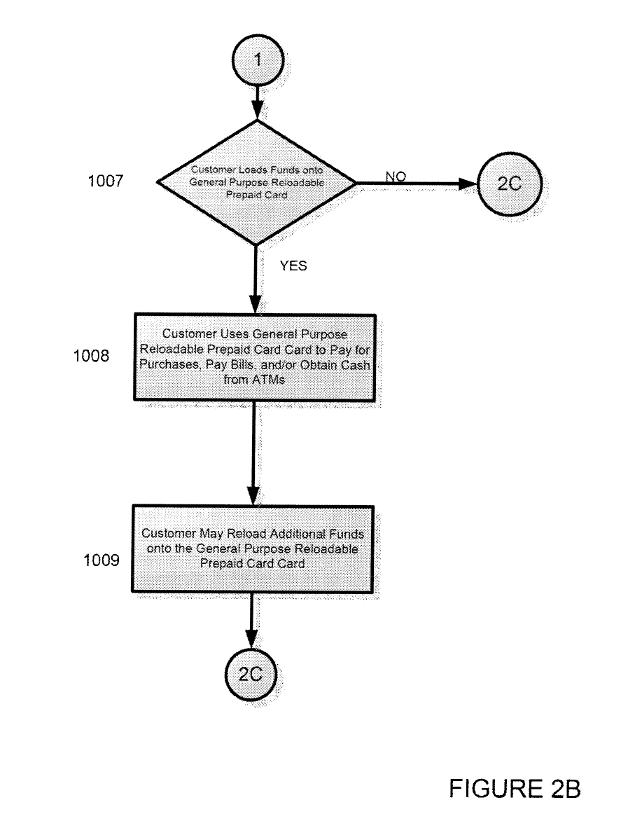

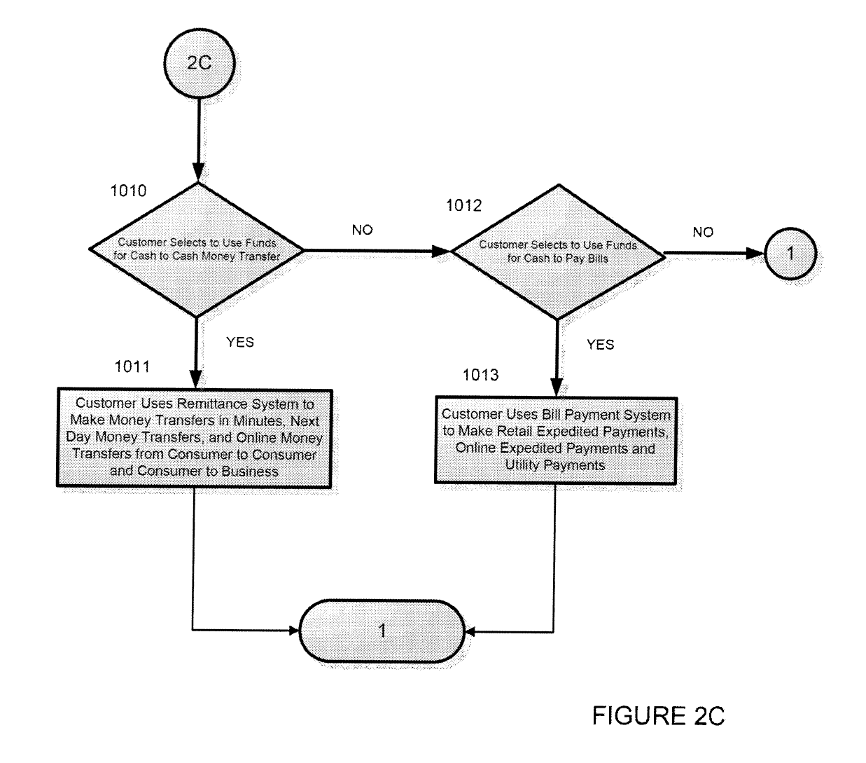

Referring to FIGS. 2A, 2B and 2C, the underbanked and unbanked module 200 illustrated in FIG. 1 may comprise an enrollment system, a data receiver 1004, a check verification system 1005, a fund dispenser 1006, a general purpose reloadable prepaid card system 1007-1009, a remittance system 1010, 1011 and a bill payment system 1012, 1013. The underbanked and unbanked module may be a processor based system and may further comprise a communications interface to FIG. 2A, an enrollment system 1001, 1002 may enroll a customer 100 in the underbanked and unbanked module 200 by verifying the name, physical address, social security number, date of birth and government issued photo ID of the customer. Once a customer 100 is enrolled in the underbanked and unbanked module 200, the data receiver 1004 receives check data and identification data from the customer 100 who presents the check to the system 1003. The check verification system 1005 may communicate with the data receiver, and may approve or decline the disbursement of funds with a full guarantee by a third party vendor. A bank teller may scan the front and back of a check, and the check data may be submitted to a third party vendor for decisioning; the third party vendor may perform OFAC scrubs in evaluating whether or not to approve disbursement of funds. If the check verification system 1005 approves the disbursement of funds, the check verification system communicates with the fund dispenser 1006, which will dispense funds. Both the check verification system and the fund dispenser may comprise a computer implemented system. The check verifying and fund dispensing may also be performed manually by an individual associated with the financial institution.

In another embodiment, the underbanked and unbanked module may provide short term loans, which are paid off by the end of the customer's next respective pay period, and loans, which are a mixture of a lease and an option to buy within a certain period of time to a customer 100. The system 1003 initiates the loan processing, and additionally may be used to provide a line of credit to a customer 100 based on the customer's deposit history, at both the location of the financial institution 300 and at a location other than the financial institution associated with the underbanked and unbanked module 200.

Referring to FIG. 2B, the customer 100 may load funds onto a general purpose reloadable prepaid card both at the financial institution 300 associated with the underbanked and unbanked module 200 and at locations other than the financial institution 300 associated with the underbanked and unbanked module 200. The general purpose reloadable prepaid card system 1007, 1008 allows the customer to use the general purpose reloadable prepaid card to pay for purchases, to pay for bills and/or to obtain cash from ATMs. Further, the general purpose reloadable prepaid card system also allows a customer 100 to reload additional funds onto the reloadable debit card 1009. The general purpose reloadable prepaid card system 1007, 1008 communicates with the financial institution 300 and initiates the transfer of a customer 100's funds to the reloadable debit card. The funds loaded onto the general purpose reloadable prepaid card may comprise cash, may be loaded from an existing account at the financial institution 300, and may be directly deposited onto the card from the customer's wages, tax refunds and/or state disbursements. Customers may purchase goods or services wherever a Visa Debit Card is accepted, and these purchases may be protected by the safeguards of the financial institution 300 associated with the underbanked and unbanked module 200.

Referring to FIG. 2C, the underbanked and unbanked module 200 may comprise a money remittance system 1010, 1011 for facilitating cash to cash money transfers, and a bill payment system 1012, 1013 to facilitate expedited bill payment to a network of billers. The system may communicate with the money remittance system 1010, 1011 and the bill payment system 1012, 1013, as the funds dispensed from the fund dispenser of the check cashing system 1003 may be used to facilitate these cash to cash money transfers, money orders and bill payments. This money remittance system 1010, 1011 and bill payment system 1012, 1013 may initiate the transfer of funds for a customer 100 to an individual, or to a business around the world via a third party vendor. Additionally, the money remittance system 1010, 1011 may provide money transfers in minutes, next day money transfers and online money transfers. The bill payment system 1012, 1013 may provide retail expedited payments, online expedited payments and utility payments.

In another embodiment a GUI will facilitate customer creation and enrollment into the full service underbanked and unbanked module including, the general purpose reloadable prepaid card system, the money remittance system and the bill payment system. An interface is created between the third party vendor that provides check verification and guarantee and the GUI to enable the underbanked and unbanked module to generate cash from a check. Another interface is created between the third party vendor that facilitates the transfer of funds for a customer to an individual or business around the world. The underbanked and unbanked module may execute a single sign on (SSO) and redirect the customer to pages hosted by the third party vendor that facilitates the transfer of funds. The session status of a customer may be maintained through a PING URL embedded in the third party header, served from the underbanked and unbanked module that the third party vendor will incorporate into its design.

In another embodiment, the general purpose reloadable prepaid card system will utilize a financial institution's current systems to provide sub-accounts to facilitate the loading of funds onto a general purpose reloadable prepaid card.

The cash banking processing sequence illustrated in FIGS. 2A, 2B and 2C need not be executed sequentially as is described. The general purpose reloadable prepaid card system 1007, 1008, money remittance system 1010, 1011, and the bill payment system 1012, 1013, of the underbanked and unbanked module, may all be integrated with each other so that the dispensed funds may be used to load a general purpose reloadable prepaid card, to facilitate cash to cash money transfers, money orders and bill payments; further, the general purpose reloadable prepaid card may be used to facilitate cash to cash money transfers, money orders and bill payments. The various cash banking (200) techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer can have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs can be installed on the internal or external storage of the general-purpose computer. Alternatively, in another implementation, application programs can be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer can include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices can themselves include the functionality of the general-purpose computer. For example, the mobile phone or the PDA can include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software can be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client can then cause the server containing a computer program to launch an application to, for example, perform an analysis according to the described techniques. In another implementation, the server can download an application to be run on the client to perform an analysis according to the described techniques.

Although the systems and methods have been described in detail, it will be apparent to those of skill in the art that the systems and methods can be embodied in a variety of specific forms and that various changes, substitutions and alterations can be made without departing from the spirit and the scope of the systems and methods described herein. The described embodiments are only illustrative and not restrictive, and the scope of the systems and methods is, therefore, indicated by the following claims. Other embodiments are within the scope of the following claims.

What is claimed is:

1. A banking method comprising:
enrolling a customer in an underbanked and unbanked module associated with a financial institution regardless of whether the customer is a deposit or non-deposit customer of said financial institution;
receiving check data and identification data from a customer;
verifying said check data and identification data;
upon verifying said check data, dispensing funds to the customer;
loading funds onto a general purpose reloadable prepaid card;
facilitating cash to cash money transfers; and
facilitating bill payments to a network of billers.

2. The banking method of claim 1 further comprising verifying the name, physical address, social security number, date of birth and government issued photo ID of the customer.

3. The banking method of claim 1 wherein the funds dispensed to the customer comprise cash.

4. The banking method of claim 1 wherein the funds dispensed to the customer are used to facilitate cash to cash money transfers, bill payments and/or money orders.

5. The banking method of claim 1 wherein the funds for the general purpose reloadable prepaid card comprise cash.

6. The banking method of claim 1 further comprising loading the general purpose reloadable prepaid card with funds from an existing account at the financial institution associated with the underbanked and unbanked module.

7. The banking method of claim 1 wherein the funds for the general purpose reloadable prepaid card are directly deposited onto the card.

8. The banking method of claim 7 wherein the funds directly deposited onto the general purpose reloadable prepaid card comprise the customer's wages, tax refunds and/or state disbursements.

9. The banking method of claim 1 wherein the funds are loaded onto the general purpose reloadable prepaid card at the financial institution associated with the underbanked and unbanked module.

10. The banking method of claim 1 wherein the funds are loaded onto the reloadable card at a network location other than the financial institution associated with the underbanked and unbanked module.

11. The banking method of claim 1 further comprising using the funds dispensed to the customer to provide a line of credit to the customer based on the customer's deposit history, at a location other than the financial institution.

12. The banking method of claim 1 further comprising using the funds dispensed to the customer to provide a short term loan or pay day advance to the customer.

13. An underbanked and unbanked module comprising:
a general purpose reloadable prepaid card system;
a money remittance system for facilitating cash to cash money transfers; and
a bill payment system;
wherein the underbanked and unbanked module generates cash from a check; and
the general purpose reloadable prepaid card system, the money remittance system and the bill payment system are integrated with each other.

14. The underbanked and unbanked module of claim 13 further comprising an enrollment system for enrolling a customer in the underbanked and unbanked module associated with a financial institution regardless of whether the customer is a deposit or non-deposit customer of said financial institution.

15. The underbanked and unbanked module of claim 13 wherein the underbanked and unbanked module is configured to verify the name, physical address, social security number, date of birth and government issued photo ID of the customer.

16. The underbanked and unbanked module of claim 13 further comprising:
a data receiver for receiving check data and identification data from a customer; and
a fund dispenser for dispensing funds associated with the check presented to the system;
wherein said underbanked and unbanked module interfaces with a check verification system to approve or decline the disbursement of funds with a full guarantee by a third party vendor.

17. The underbanked and unbanked module of claim 16 wherein the funds dispensed from the underbanked and unbanked module comprise cash.

18. The underbanked and unbanked module of claim 16 wherein the funds dispensed from the unbanked and underbanked module are loaded onto a general purpose reloadable prepaid card.

19. The underbanked and unbanked module of claim 16 wherein the funds dispensed from the underbanked and unbanked module are deposited into a savings account.

20. The underbanked and unbanked module of claim 16 wherein the funds dispensed from the underbanked and unbanked module are used to facilitate cash to cash money transfers, bill payments and/or money orders.

21. The underbanked and unbanked module of claim 14 wherein the general purpose reloadable prepaid card system, the money remittance system and the bill payment system are integrated with each other to allow a customer to use the funds dispensed from the underbanked and unbanked module to obtain cash, load a general purpose reloadable prepaid card, pay for purchases, pay bills, obtain a money order and/or to facilitate cash to cash money transfers.

22. The underbanked and unbanked module of claim 13 wherein the underbanked and unbanked module for provides a line of credit to the customer based on the customer's deposit history, at the financial institution and/or at a location other than the financial institution associated with the underbanked and unbanked module.

23. The underbanked and unbanked module of claim 13 wherein the underbanked and unbanked module for provides short term loans, which are paid off by the end of the customer's next respective pay period, and loans, which are a mixture of a lease and an option to buy within a certain period of time.

24. The underbanked and unbanked module of claim 13 wherein:
the customer loads funds onto a general purpose reloadable prepaid card;
the customer uses the card to pay for purchases, pay bills and/or obtain cash from ATMs; and
the customer may reload additional funds onto the card.

25. The underbanked and unbanked module of claim 24 wherein the funds for the general purpose reloadable prepaid card comprise cash.

26. The underbanked and unbanked module of claim 24 wherein the funds for the general purpose reloadable prepaid card are loaded from an existing account at the financial institution.

27. The underbanked and unbanked module of claim 24 wherein the funds for the general purpose reloadable prepaid card are directly deposited onto the card.

28. The underbanked and unbanked module of claim 27 wherein the funds directly deposited onto the general purpose reloadable prepaid card comprise the customer's wages, tax refunds and/or state disbursements.

29. The underbanked and unbanked module of claim 24 wherein the funds are loaded onto the general purpose reloadable prepaid card at the financial institution associated with the underbanked and unbanked module.

30. The underbanked and unbanked module of claim 24 wherein the funds are loaded onto the general purpose reloadable prepaid card at a network location other than the financial institution associated with the underbanked and unbanked module.
